(19) United States
(12) Patent Application Publication
(10) Pub. No.: US 2015/0301305 A1
(43) Pub. Date: Oct. 22, 2015

(54) LENS DRIVE APPARATUS AND CAMERA MODULE

(71) Applicant: SHARP KABUSHIKI KAISHA, Osaka-shi, Osaka (JP)

(72) Inventors: Hisateru OKAI, Osaka-shi, Osaka (JP); Hiroshi YOKOTA, Osaka-shi, Osaka (JP); Satoshi YASUKOCHI, Osaka-shi, Osaka (JP)

(21) Appl. No.: 14/423,539

(22) PCT Filed: Jul. 30, 2013
(86) PCT No.: PCT/JP2013/070639

§ 371 Date: Feb. 24, 2015

(30) Foreign Application Priority Data
Aug. 31, 2012 (JP) 2012-192492

(51) Int. Cl. G02B 7/09; H04N 5/225

(52) U.S. Cl. CPC G02B 7/09; H04N 5/2254

(57) ABSTRACT

The present invention makes it possible to more accurately determine a position of an imaging lens with respect to an imaging element at low cost. A lens holder (1) is provided with a holder tapered surface (12), and a base (3) is provided with a holder tapered engaging surface (31). When the lens holder (1) is supported by the base (3), the holder tapered surface (12) and the holder tapered engaging surface (31) engage with each other.

### TECHNICAL FIELD

The present invention relates to (i) a lens drive device that can realize an autofocus function and (ii) a camera module including such a lens drive device and having the autofocus function.

### BACKGROUND ART

Presently, most mobile terminals such as mobile phones are each mounted with a small-sized camera module including a lens drive device (so-called “actuator”) that can realize an autofocus function, and each have an imaging function.

In a conventional camera module, an initial adjustment of a focus position at infinity (i.e., a search for a focus position at infinity) is performed mainly according to the following procedure.

First, an imaging element, an imaging element cover, a lens drive device, and the like are mounted on a substrate. Next, a lens barrel holding an imaging lens is incorporated into a lens holder from above the lens drive device. Then, the imaging element gets started operating, and while an appropriate chart is being imaged by the imaging lens and the imaging element, a height of the lens barrel is adjusted so that the imaging lens is located at a (focus) position where the chart is seen most clearly.

Note that the height of the lens barrel is adjusted according to the following procedure.

First, screw threads adopted to engage with each other are provided on an outer wall surface of the lens barrel and an inner wall surface of the lens holder, respectively. Then, by screwing the screw thread on the lens barrel into the screw thread on the lens holder, the lens barrel is incorporated into the lens holder. During this incorporation, the height of the lens barrel (and, by extension, the imaging lens) with respect to the imaging element can be adjusted according an amount by which the screw thread on the lens barrel has been screwed.

On the other hand, there has been known a technology for structurally determining the height of an imaging lens with respect to an imaging element instead of performing an initial adjustment of a focus position at infinity as described above. Such a technology is disclosed in Patent Literature 1.

In a camera module disclosed in Patent Literature 1, a bottom part of a leg of the lens barrel abuts an upper surface of a sensor cover or an upper surface of a base constituting a bottom part of the lens drive device (including a member formed integrally with the sensor cover). This makes it possible to determine, according to a structure of the camera module, a position of the imaging lens that corresponds to an initial focus position at infinity.

In a camera module including a lens drive device of a voice coil motor (hereinafter referred to simply as “VCM”) type, there has been known a conventional technology for, in order to realize miniaturization, holding an imaging lens on an inner wall of a lens holder without using a lens barrel. Such a technology is disclosed in Patent Literature 2. An imaging device disclosed in Patent Literature 2 can be made in a smaller size by the thickness of the existing lens barrel.

In the imaging device disclosed in Patent Literature 2, an initial adjustment of a focus position at infinity is performed according to the following procedure.

First, an image sensor is mounted on a substrate by die bonding and wire bonding, and after a lower cylinder is mounted to a place on the substrate where the image sensor has been mounted, a lens drive device is assembled on an upper surface of the lower cylinder. During this assembly process, an imaging lens constituted by a plurality of lenses fitted on top of each other is placed on an IR (infrared) cut filter, and detection light is concentrated on a light-receiving surface of the image sensor by the imaging lens. At this point in time, an output signal from the image sensor is measured, and a space between the image sensor and the imaging lens is adjusted according to a result of the measurement so that an appropriate focus position is achieved. This is how an initial adjustment of a focus position at infinity is performed. After the adjustment, the imaging lens is fitted into the lens holder with the image sensor and the imaging lens kept at the distance as determined by the adjustment, and is fixed to the lens holder with an adhesive.

### CITATION LIST

Patent Literature 1

Japanese Patent Application Publication, Tokukai, No. 2010-134409 A (Publication Date: Jun. 17, 2010)

Patent Literature 2

Japanese Patent Application Publication, Tokukai, No. 2007-121849 A (Publication Date: May 17, 2007)

### SUMMARY OF INVENTION

### Technical Problem

The performance of a camera module depends not only on the performance of a single member (such as an imaging lens, an imaging element, or the like) but also on variations in the dimensions of the members, assembly accuracy, and the like. Therefore, a process of assembling a camera module requires high accuracy. In terms of assembly accuracy, it is preferable that a positional misalignment between an optical axis of the imaging lens and a center of a light-receiving surface of the imaging element be small. Further, it is preferable that the optical axis of the imaging lens be parallel to a line normal to the imaging element.

The term “positional misalignment” as used herein means a positional misalignment in terms of a direction perpendicular to the optical axis of the imaging lens housed in the lens holder.

The “center” as used herein means a part constituting the center in a direction perpendicular to the optical axis of the imaging lens housed in the lens holder. In the case of a surface, the “center” is a point. In the case of a solid, the “center” is a line. For example in the case of a cylindrical member extending along the optical axis, the “center” is an axis. In addition, in the case of a hollow member, a position corresponding to the “center” may be a space.

Note here that assuming the light-receiving surface of the imaging element is a geometric surface, the “line normal to the imaging element” corresponds to a line normal to the geometric surface, and it is preferable that the line pass through the center of the light-receiving surface. Further, an “angular misalignment between the optical axis of the imaging lens and a line normal to the imaging element” means a state in which the angle formed by the optical axis of the imaging lens and the light-receiving surface of the imaging element does not take on the desired value (i.e., 90°), and is synonymous with a misalignment of a tilt in the imaging lens.

Note that an amount of positional misalignment between the optical axis of the imaging lens and the center of the light-receiving surface of the imaging element is expressed by a total sum of an amount of positional misalignment between the center of the light-receiving surface of the imaging element and a center of the sensor cover, an amount of positional misalignment between the center of the sensor cover and a center of the base of the lens drive device, an amount of positional misalignment between the center of the base and the center of the lens holder, and an amount of positional misalignment between the center of the lens holder and the center of the imaging lens.

Further, an amount of angular misalignment (tilt) between the optical axis of the imaging lens and the line normal to the imaging element is one obtained when the imaging element, the substrate, the sensor cover, the base, the lens holder, and the imaging lens are assembled. This amount can be interpreted as an inclination of the imaging lens.

The camera module disclosed in Patent Literature 1 does not include a structure for determining a positional relationship between the center of the base and the center of the lens holder. Therefore, if accuracy of dimension and/or assembly of the members constituting the base and the lens holder is not sufficient, the amount of positional misalignment between the optical axis of the imaging lens and the center of the light-receiving surface of the imaging element may become so large that the camera module may become unable to sufficiently exhibit its performance.

The imaging device disclosed in Patent Literature 2 can achieve a constant space between the image sensor and the imaging lens, but does not seem to include a structure for determining a positional relation between the optical axis of the imaging lens and the center of the light-receiving surface of the imaging element. Therefore, if accuracy of dimension and/or assembly of all of the members are/is not sufficient, the amount of positional misalignment between the optical axis of the imaging lens and the center of the light-receiving surface of the imaging element may become so large that the camera module may become unable to sufficiently exhibit its performance.

Moreover, the amount of angular misalignment between the optical axis of the imaging lens and the line normal to the imaging element depends on assembly accuracy. Therefore, without a high-accuracy assembly apparatus, the amount of angular misalignment may become so large (the imaging lens may become so inclined) that the camera module may become unable to sufficiently exhibit its performance.

In addition, in the case of a structure in which the imaging lens is held on the inner wall of the lens holder of the lens drive device, the imaging device disclosed in the Patent Literature 2 requires an initial adjustment of a focus position at infinity as described above, and this adjustment is complicating. This makes it necessary to use a high-accuracy assembly apparatus in the manufacture of the imaging device disclosed in Patent Literature 2, thus undesirably causing an increase in manufacturing cost.

The present invention has been made in view of the problems described above, and it is an object of the present invention to provide (i) a lens drive device that makes it possible to more highly accurately determine a position of an imaging lens with respect to an imaging element at low cost and (ii) a camera module including such a lens drive device.

### Solution to Problem

In order to solve the problems described above, a first lens drive device of the present invention is a lens drive device including: a lens holder within which an imaging lens is housed; and a base constituting a bottom part and supporting the lens holder, the lens holder being provided with a holder tapered surface having a taper shape whose diameter becomes smaller from an upper surface side of the base toward to a bottom surface side of the base, the base being provided with a holder tapered engaging surface that engages with the holder tapered surface, when the lens holder is supported by the base, the holder tapered surface and the holder tapered engaging surface engaging with each other.

In order to solve the problems described above, a second lens drive device of the present invention is a lens drive device comprising: a lens holder within which an imaging lens is housed; and a base constituting a bottom part and supporting the lens holder, the base being an annular member, the lens holder being provided with a first protrusion formed on the bottom part of the lens holder and a second protrusion formed on an outer wall of a side surface of the lens holder, when the lens holder is supported by the base, the first protrusion passing through a space defined by the base and the second protrusion abutting an upper surface of the base in such a manner as to suppress an inclination of the imaging lens.

### Advantageous Effects of Invention

In an aspect of the present invention, it is possible to provide a lens drive device that makes it possible to more highly accurately determine a position of an imaging lens with respect to an imaging element at low cost and (ii) a camera module including such a lens drive device.

### BRIEF DESCRIPTION OF DRAWINGS

FIG. 1 is a cross-sectional view showing a configuration of a lens drive device according to Embodiment 1.

FIG. 2 is a cross-sectional view showing a configuration of a lens drive device according to Embodiment 2.

FIG. 3 is a cross-sectional view showing a configuration of a lens drive device according to Embodiment 3.

FIG. 4 is a cross-sectional view showing a configuration of a lens drive device according to Embodiment 4.

FIG. 5 is a cross-sectional view showing a configuration of a camera module according to an embodiment of the present invention.

### DESCRIPTION OF EMBODIMENTS

### Embodiment 1

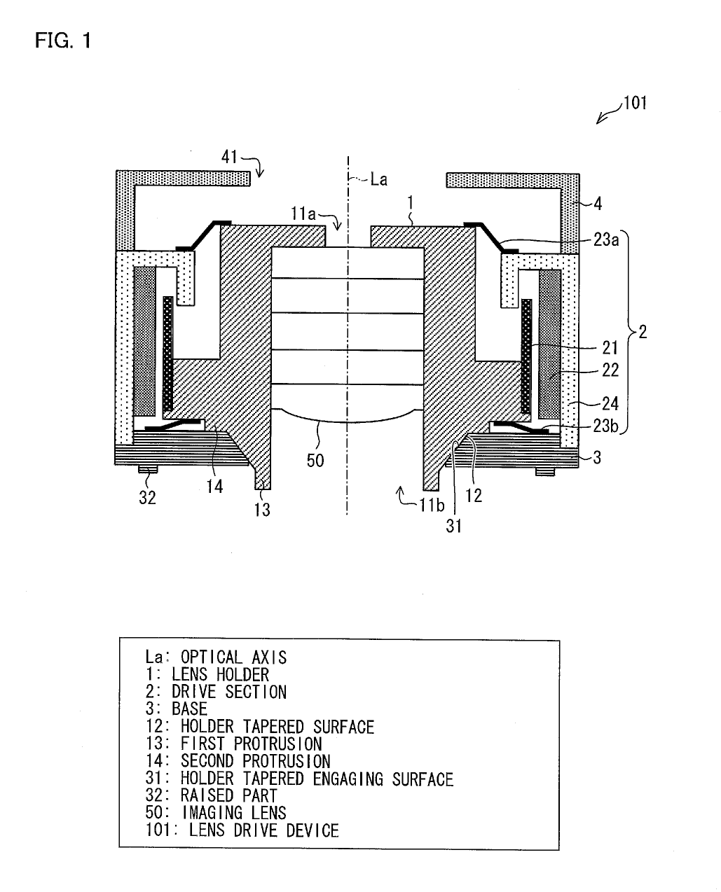

FIG. 1 is a cross-sectional view showing a configuration of a lens drive device according to Embodiment 1.

A lens drive device 101 shown in FIG. 1 includes a lens holder 1, a drive section 2, a base 3, and an upper cover 4.

For convenience, the following description expresses an upper cover 4 side of the lens drive device 101 as “upper” (i.e., upper part, upper side, etc.) and a base 3 side of the lens drive device 101 as “lower” (i.e., lower part, lower side, etc.).

The lens holder 1 is a cylindrical member, and is configured to house an imaging lens 50 therewithin. The lens holder 1 has an axis (center) that coincides with an optical axis La of the imaging lens 50.

The lens holder 1 has an opening 11a in an upper surface (top surface) thereof. The lens holder 1 has an opening 11b in a bottom surface thereof. The opening 11a is smaller in diameter than the opening 11b. This is intended to make it easier to hold the imaging lens 50 on an inner wall of the upper surface of the lens holder 1 and to limit a diameter of light incident on the imaging lens 50 (i.e., to allow the opening 11a to function as an aperture stop).

Further, the imaging lens 50 shown in FIG. 1 is a lens unit constituted by a plurality of lenses. However, the imaging lens 50 may be constituted by a single lens.

The drive section 2 displaces the lens holder 1 along the optical axis La of the imaging lens 50 housed within the lens holder 1.

Specifically, the drive section 2 includes a drive coil 21, a permanent magnet 22, an upper plate spring 23a, a lower plate spring 23b, and a yoke 24.

The drive coil 21 is attached to an outer wall of a side surface of the lens holder 1.

The permanent magnet 22 is placed opposite the drive coil 21, and constitutes a magnetic circuit.

The upper plate spring 23a one end attached to an outer wall of the upper surface of the lens holder 1 and the other end attached to an upper surface of the yoke 24. The lower plate spring 23b has one end attached to the outer wall of the side surface of the lens holder 1 and the other end attached to an upper surface of the base 3.

The yoke 24 is a tubular member, and constitutes a side surface of the drive section 2. The yoke 24 is fixed on the base 3.

The drive coil 21 and the permanent magnet 22 generate an electromagnetic force. In accordance with this electromagnetic force, the upper plate spring 23a and the lower plate spring 23b displace the lens holder 1 along the optical axis La of the imaging lens 50. This enables the drive section 2 to displace the lens holder 1.

The base 3 constitutes a bottom part of the lens drive device 101. In other words, the lens holder 1, the drive section 2, and the upper cover 4 are provided above the base 3.

Further, the base 3 is configured to support the lens holder 1. Support of the lens holder 1 by the base 3 is described in detail later.

The upper cover 4 is provided on the upper surface of the yoke 24, and constitutes an upper surface of the lens drive device 101. The upper cover 4 has an opening 41 provided therein to secure an optical path of light incident on the imaging lens 50. Note that the upper cover 4 may be omitted and the yoke 24 may have the function of the upper cover 4 (in which case, the opening 41 is provided in the yoke 24).

The lens drive device 101 can be said to be a lens drive device of a VCM type.

Note here that the lens holder 1 is provided with a holder tapered surface 12. The holder tapered surface 12 has a taper shape whose diameter becomes smaller from an upper surface side of the base 3 toward a bottom surface side of the base 3.

Meanwhile, the base 3 is provided with a holder tapered engaging surface 31 that engages with the holder tapered surface 12. Specifically, the holder tapered engaging surface 31 has a shape directly opposite to (symmetrical with) the taper shape provided as the holder tapered surface 12, and can be said to be a surface adjacent to a tapered space.

Moreover, in the lens drive device 101, the lens holder 1 is supported by the base 3. At this time, the holder tapered surface 12 abuts the holder tapered engaging surface 31, whereby the holder tapered surface 12 and the holder tapered engaging surface 31 engage with each other.

This makes it possible to fix the lens holder 1 with respect to the base 3. When the lens holder 1 is fixed, a positional relationship between a center of the base 3 and a center of the lens holder 1 is uniquely determined, and an inclination of the lens holder 1 with respect to the base 3 is also uniquely determined.

As a result, in a case where a camera module is configured by combining the lens drive device 101 with an imaging element (which will be described in detail later) or the like, it is possible to reduce an amount of positional misalignment between the optical axis La of the imaging lens 50 and a center of a light-receiving surface of the imaging element. Further, in this case, it is also possible to reduce an amount of angular misalignment between the optical axis La of the imaging lens 50 and a line normal to the imaging element. This makes it possible to more highly accurately determine a position of the imaging lens 50 with respect to the imaging element.

In the lens drive device 101, the lens holder 1 and the base 3 abut and engage with each other via tapered parts having shapes symmetrical with each other.

Further, according to FIG. 1, the base 3 is an annular member.

Furthermore, the lens holder 1 is provided with a first protrusion 13 from a bottom part of the lens holder 1, and with a second protrusion 14 from the outer wall of the side surface of the lens holder 1.

Moreover, in the lens drive device 101, the lens holder 1 is supported by the base 3. At this time, the first protrusion 13 passes through a space defined by the base 3, and the second protrusion 14 abuts the upper surface of the base 3 in such manner as to suppress the inclination of the imaging lens 50.

More specifically, the first protrusion 13 passes through a hollow portion of the base 3 as the space defined by the base 3. The second protrusion 14 adjusts the inclination of the lens holder 1 according to an angle of inclination of a surface abutting the upper surface of the base 3. This makes it possible to suppress the inclination of the imaging lens 50.

As a result, in a case where a camera module is configured by combining the lens drive device 101 with the imaging element and the like, it is possible to reduce an amount of angular misalignment between the optical axis La of the imaging lens 50 and the line normal to the imaging element. In addition, in this case, the first protrusion 13 can be caused to surely abut the sensor cover (which will be described in detail later) covering the imaging element. This abutment makes it possible to more surely determine the position of the imaging lens 50 with respect to the imaging element. This makes it possible to more highly accurately determine the position of the imaging lens 50 with respect to the imaging element.

Further, the lens drive device 101 can sufficiently highly accurately determine the position of the imaging lens 50 with respect to the imaging element without the need to performing an initial adjustment of a focus position at infinity. This makes it unnecessary to use a high-accuracy assembly apparatus and possible to hope for a reduction in manufacturing cost of the camera module.

Note that while the lens drive device 101 has the holder tapered surface 12, the holder tapered engaging surface 31, the first protrusion 13, and the second protrusion 14, it is not essential that the lens drive device 101 have all of them. That is, the lens drive device according to the present invention may be configured to include at least the holder tapered surface 12 and the holder tapered engaging surface 31, or may be configured to include at least the first protrusion 13 and the second protrusion 14.

For convenience of illustration and explanation, FIG. 1 illustrates a configuration in which the imaging lens 50 is housed in the lens holder 1 of the lens drive device 101. However, this merely means that the lens drive device 101 allows the imaging lens 50 to be housed in the lens holder 1. In other words, the imaging lens 50 is not to be counted as a component of the lens drive device 101. The same applies to the after-mentioned lens drive devices 102 to 104.

In addition, the lens drive device 101 has a raised part 32 provided on a bottom surface of the base 3.

The raised part 32 will be described in detail later.

### Embodiment 2

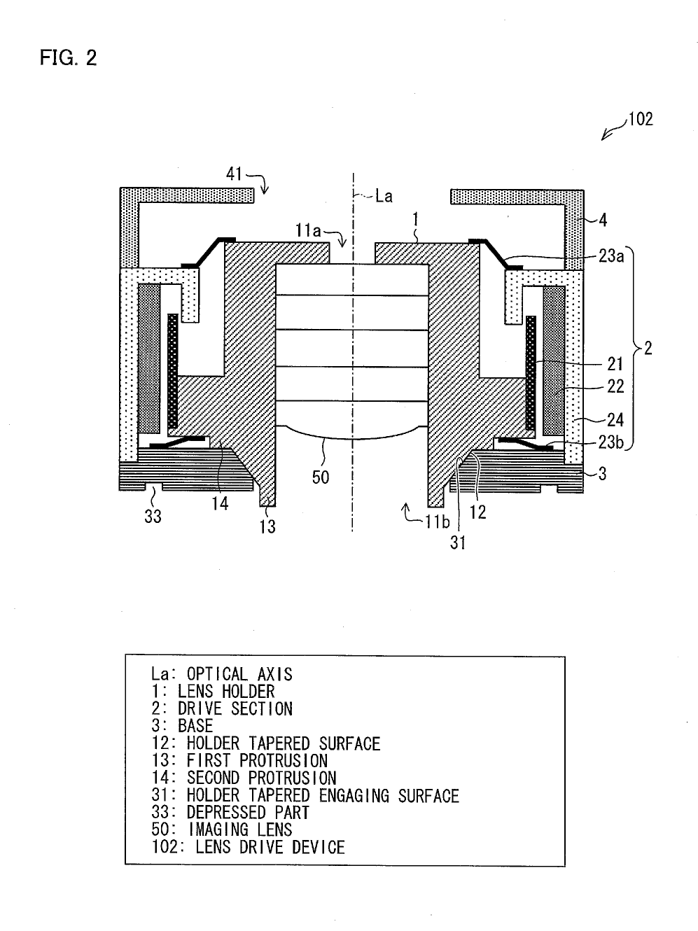

FIG. 2 is a cross-sectional view showing a configuration of a lens drive device according to Embodiment 2.

A lens drive device 102 shown in FIG. 2 differs from the lens drive device 101 shown in FIG. 1 in that the lens drive device 102 is not provided with a raised part 32 but provided with a depressed part 33.

As with the raised part 32, the depressed part 33 is provided in the bottom surface of the base 3.

The depressed part 33 will be described in detail later.

The lens drive device 102 brings about the same working effects as a lens drive device as those which are brought about by the lens drive device 101.

### Embodiment 3

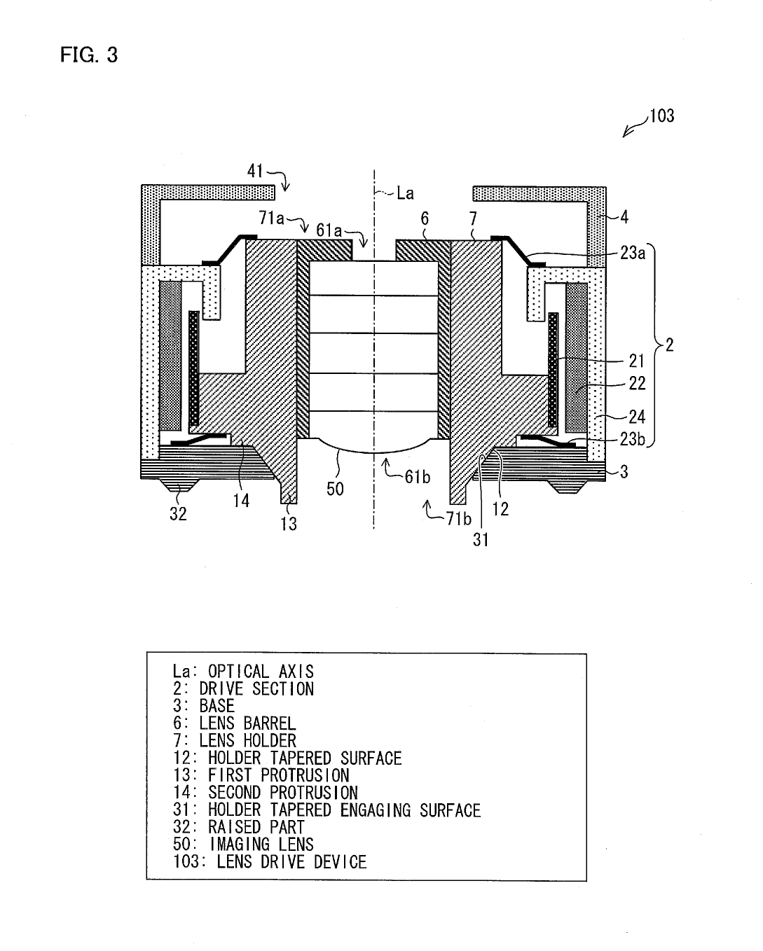

FIG. 3 is a cross-sectional view showing a configuration of a lens drive device according to Embodiment 3.

The lens drive device 101 shown in FIG. 1 and the lens drive device 102 shown in FIG. 2 both do not include a lens barrel. That is, the lens drive devices 101 and 102 are both structured to hold the imaging lens 50 on the inner wall of the lens holder 1 without using a lens barrel.

On the other hand, a lens drive device 103 shown in FIG. 3 includes a lens barrel 6.

The lens barrel 6 is a cylindrical member, is housed within a lens holder 7, and houses the imaging lens 50 therewithin.

Note here that the lens holder 7 is a cylindrical member, and houses and holds the lens barrel 6 in which the imaging lens 50 is housed. The lens holder 7 is the same as the lens holder 1 in that the lens holder 7 includes a holder tapered surface 12, a first protrusion 13, and a second protrusion 14.

Note that a combination of the lens barrel 6 and the lens holder 7 in the lens drive device 103 shown in FIG. 3 has the same shape as the lens holder 1, but is not limited to this shape.

A configuration in which the lens barrel 6 housing the imaging lens 50 therewithin is housed within the lens holder 7, too, can be said to be an example of a configuration in which “an imaging lens is housed within a lens holder”.

The lens holder 7 has an opening 71a in an upper surface thereof. The lens holder 7 has an opening 71b in a bottom surface thereof. The opening 71a is substantially equal in diameter to the opening 71b. On the other hand, the lens barrel 6 is inserted into a hollow portion of the lens holder 7, which is cylindrical. The lens barrel 6 has an opening 61a in an upper surface thereof. The lens barrel 6 has an opening 61b in a bottom surface of therefore. The opening 61a is smaller in diameter than the opening 61b. This is intended to make it easier to hold the imaging lens 50 on an inner wall of the upper surface of the lens barrel 6 and to limit a diameter of light incident on the imaging lens 50 (i.e., to allow the opening 61a to function as an aperture stop).

Further, as with the lens drive device 101, the lens drive device 103 shown in FIG. 3 has a raised part 32 provided on a bottom surface of the base 3. However, the lens drive device 103 differs from the lens drive device 101 in that the raised part 32 of the lens drive device 103 has an outer shape that is tapered.

The raised part 32 will be described in detail later.

The lens drive device 103 brings about the same working effects as a lens drive device as those which are brought about by the lens drive device 101.

### Embodiment 4

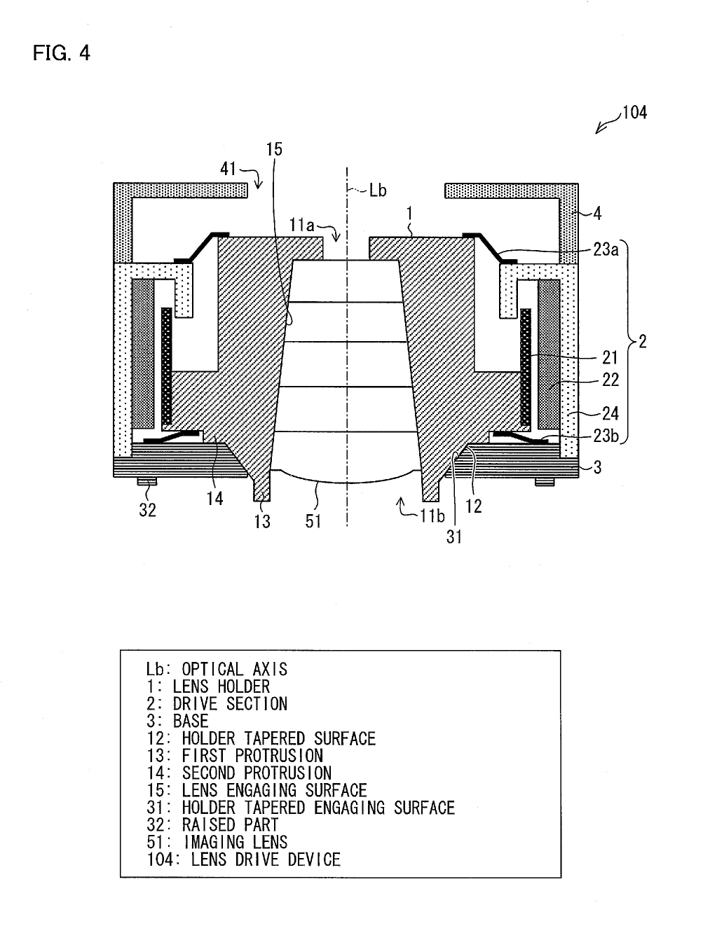

FIG. 4 is a cross-sectional view showing a configuration of a lens drive device according to Embodiment 4.

It should be noted, prior to a description of the lens drive device that an imaging lens 51 is substantially in the shape of a truncated cone. In other words, the imaging lens 51 differs from the imaging lenses 50 shown in FIGS. 1 through 3 in that the imaging lens 51 has an outer shape that is tapered. In FIG. 4, the imaging lens 51 has an optical axis Lb. The lens holder 1 has an axis (center) that coincides with the optical axis Lb of the imaging lens 51.

A lens drive device 104 shown in FIG. 4 differs from the lens drive device 101 shown in FIG. 1 in that the lens holder 1 has its inner wall provided with a lens engaging surface 15 that engages with the outer shape of the imaging lens 51.

Specifically, the lens engaging surface 15 has a shape directly opposite to (symmetrical with) the taper shape provided as an outer wall of the imaging lens 51, and can be said to be a surface adjacent to a tapered space.

Moreover, in the lens drive device 104, the imaging lens 51 is held by the lens holder 1. At this time, the outer wall of the imaging lens 51 abuts the lens engaging surface 15, whereby the outer wall of the imaging lens 51 and the lens engaging surface 15 engage with each other.

This makes it possible to fix the imaging lens 51 with respect to the lens holder 1. When the imaging lens 51 is fixed, a positional relationship between the center of the lens holder 1 and a center of the imaging lens 51 is uniquely determined, and an inclination of the imaging lens 51 with respect to the lens holder 1 is also uniquely determined.

As a result, in a case where a camera module is configured by combining: the lens drive device 104 with an imaging element (which will be described in detail later) or the like, it is possible to reduce an amount of positional misalignment between the optical axis Lb of the imaging lens 51 and a center of a light-receiving surface of the imaging element. Further, in this case, it is also possible to reduce an amount of angular misalignment between the optical axis Lb of the imaging lens 51 and a line normal to the imaging element. This makes it possible to more highly accurately determine a position of the imaging lens 51 with respect to the imaging element.

[Modification of Embodiment 4]

The lens drive device shown in FIG. 4 is not configured to include a lens barrel, but may include a lens barrel. That is, a feature configuration of the lens drive device 104 is applicable to a lens drive device including a lens barrel.

For example, a configuration of the outer shape of the imaging lens 51 is applicable to a configuration of the outer shape of the lens barrel 6. In this case, the lens barrel has an outer shape that is tapered, and the lens holder 7 has its inner wall provided with a barrel engaging surface (not illustrated) that engages with the outer shape of the lens barrel 6.

This makes it possible to fix the lens barrel 6 with respect to the lens holder 7. When the lens barrel 6 is fixed, a positional relationship between a center of the lens holder 7 and a center of the lens barrel is uniquely determined, and an inclination of the lens barrel 6 with respect to the lens holder 7 is also uniquely determined.

[Camera Module]

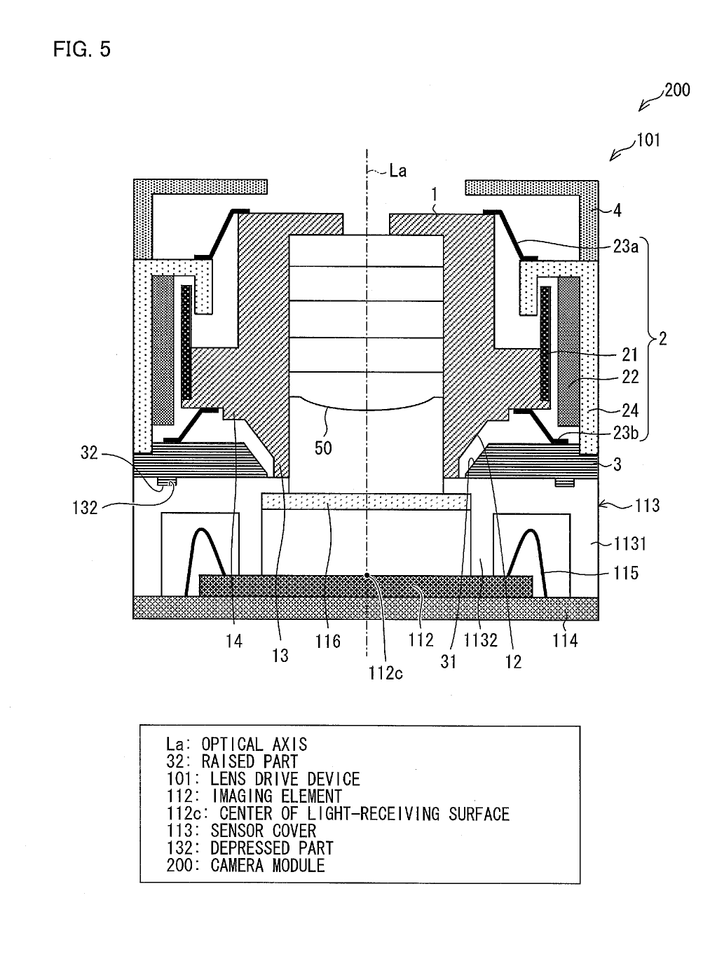

FIG. 5 is a cross-sectional view showing a configuration of a camera module according to an embodiment of the present invention.

An example where a camera module is configured by using the lens drive device 101 (see FIG. 1) is mainly described here with reference to FIG. 5. Meanwhile, in each case where a camera module is configured by using any of the lens drive devices 102 to 104 (see FIGS. 2 to 4), it is clearly specified which one of the lens drive drives 102 to 104 is used.

A camera module 200 shown in FIG. 5 includes the lens drive device 101, an imaging element (sensor) 112, a sensor cover 113, a substrate 114, a bonding wire 115, and an infrared cut filter 116.

The imaging element 112 receives light having passed through the imaging lens 50 housed within the lens holder 1 of the lens drive device 101. As the imaging element 112, a CCD (charge-coupled device) a sensor, a CMOS (complementary metal oxide semiconductor) sensor, or the like can be used. The imaging element 112, is placed so that a light-receiving surface of the imaging element 112 has its center 112c located on the optical axis La of the imaging lens 50 (Note that the light-receiving surface per se is not illustrated.).

The sensor cover 113 covers the imaging element 112. The sensor cover 113 covers the imaging element 112 except for the light-receiving surface of the imaging element 112.

The sensor cover 113 includes a leg 1131 and a leg 1132. The leg 1131 is put on the substrate 114. Meanwhile, the leg 1132 is put on an upper surface of the imaging element 112 (except for the light-receiving surface). This causes space between the imaging element 112 and an upper surface of the sensor cover 113 to be fixed at a unique distance.

The substrate 114 is a substrate on which the imaging element 112 and the sensor cover 113 are mounted. The bonding wire 115 realizes an electrical connection between the imaging element 112 and the substrate 114. The infrared cut filter 116 is a filter having a function to block infrared light, and is provided between the imaging lens 50 and the light-receiving surface of the imaging element 112.

Note here that the sensor cover 113 has a depressed part 132 in a position opposite to the raised part 32 of the base 3. The depressed part 132 has a shape directly opposite to (symmetrical with) the shape of the raised part 32. The depressed part 132 engages with the raised part 32 when the lens drive device 101 is mounted on the sensor cover 113. Specifically, the raised part 32 is tightly inserted into the depressed part 132.

This makes it possible to highly accurately align the lens drive device 101 and the sensor cover 113 with each other. As a result, in the camera module 200, it is possible to reduce an amount of positional misalignment between the optical axis La of the imaging lens 50 and the center 112c of the light-receiving surface of the imaging element 112. Further, in this case, it is also possible to reduce an amount of angular misalignment between the optical axis La of the imaging lens 50 and a line normal to the imaging element 112. This makes it possible to more highly accurately determine the position of the imaging lens 50 with respect to the imaging element 112.

In the case of the lens drive device 102 (see FIG. 2), in which the base 3 has the depressed part 33 provided in the bottom part thereof, the same effects as those described above can be brought about by providing the sensor cover 113 with not the depressed part 132 but a raised part (not illustrated) that has a shape directly opposite to (symmetrical with) the shape of the depressed part 33 and that engages with the depressed part 33 when the lens drive device 102 is mounted on the sensor cover 113. In this case, specifically, the raised part of the sensor cover 113 is tightly inserted into the depressed part 33.

Further, in the case of the lens drive device 103 (see FIG. 3), in which the outer shape of the raised part 32 is tapered, the same effects as those described above can be brought about by providing, on an inner wall of the depressed part 132, a raised-part-engaging surface (not illustrated) that engages with the outer shape of the raised part 32. Specifically, the raised part 32, whose outer shape is tapered, is tightly inserted into the depressed part 132, which has the raised-part-engaging surface. This shows that the “raised-part-engaging surface” is a surface having a shape directly opposite to (symmetrical with) the taper shape provided as the raised part 32.

In addition, in a case where the outer shape of the raised part 32 is tapered and the depressed part 132 has the raised-part-engaging surface, the lens drive device 103 can be fixed with respect to the sensor cover 113. When the lens drive device 103 is fixed, a positional relationship between a center of the sensor cover 113 and a center of the lens drive device 103 is uniquely determined and an inclination of the lens drive device 103 with respect to the sensor cover 113 is also uniquely determined.

The first protrusion 13 of the lens holder 1 is in abutment with the upper surface of the sensor cover 113. When the presence of the raised part 32 and the depressed part 132 is ignored, the upper surface of the sensor cover 113 is in abutment with the bottom surface of the base 3. Furthermore, the first protrusion 13 originally passes through a space defined by the base 3, and therefore has its tip located below the bottom surface of the base 3.

Because of the above positional relationship between the base 3, the first protrusion 13, and the upper surface of the sensor cover 113, the lens holder 1 is held lifted from the base 3 by the sensor cover 113 when the first protrusion 13 is in abutment with the upper surface of the sensor cover 113. At this time, the lens holder 1 is lifted until the tip of the first protrusion 13 reaches a height of the bottom surface of the base 3. However, a lens holder having no first protrusion 13 may not be lifted.

### SUMMARY

In order to solve the problems described above, a lens drive device according to one aspect of the present invention is a lens drive device including: a lens holder within which an imaging lens is housed; and a base constituting a bottom part and supporting the lens holder, the lens holder being provided with a holder tapered surface having a taper shape whose diameter becomes smaller from an upper surface side of the base toward to a bottom surface side of the base, the base being provided with a holder tapered engaging surface that engages with the holder tapered surface, when the lens holder is supported by the base, the holder tapered surface and the holder tapered engaging surface engaging with each other.

According to the configuration described above, when the lens holder is supported by the base, the holder tapered surface and the holder tapered engaging surface engage with each other. This makes it possible to fix the lens holder with respect to the base. Further, when the lens holder is fixed, a positional relationship between a center of the base and a center of the lens holder is uniquely determined, and an inclination of the lens holder with respect to the base is also uniquely determined.

As a result, in a case where a camera module is configured by combining the lens drive device with an imaging element or the like, it is possible to reduce an amount of positional misalignment between the optical axis of the imaging lens and a center of a light-receiving surface of the imaging element. In this case, it is also possible to reduce an amount of angular misalignment between the optical axis of the imaging lens and a line normal to the imaging element. This makes it possible to more highly accurately determine a position of the imaging lens with respect to the imaging element.

Further, according to the configuration described above, the lens drive device can sufficiently highly accurately determine the position of the imaging lens with respect to the imaging element without the need to performing an initial adjustment of a focus position at infinity. This makes it unnecessary to use a high-accuracy assembly and possible to hope for a reduction in manufacturing cost of the camera module.

In order to solve the problems described above, a lens drive device according to one aspect of the present invention is a lens drive device including: a lens holder within which an imaging lens is housed; and a base constituting a bottom part and supporting the lens holder, the base being an annular member, the lens holder being provided with a first protrusion formed on the bottom part of the lens holder and a second protrusion formed on an outer wall of a side surface of the lens holder, when the lens holder is supported by the base, the first protrusion passing through a space defined by the base and the second protrusion abutting an upper surface of the base in such a manner as to suppress an inclination of the imaging lens.

According to the configuration described above, when the lens holder is supported by the base, the second protrusion abuts the upper surface of the base in such a manner as to suppress the inclination of the imaging lens.

As a result, in a case where a camera module is configured by combining the lens drive device with an imaging element or the like, it is possible to reduce an amount of positional misalignment between the optical axis of the imaging lens and a center of a light-receiving surface of the imaging element. In addition, in this case, the first protrusion can be caused to surely abut the sensor cover covering the imaging element. This abutment makes it possible to more surely determine a position of the imaging lens with respect to the imaging element. This makes it possible to more highly accurately determine the position of the imaging lens with respect to the imaging element.

Further, according to the configuration described above, the lens drive device can sufficiently highly accurately determine the position of the imaging lens with respect to the imaging element without the need to performing an initial adjustment of a focus position at infinity. This makes it unnecessary to use a high-accuracy assembly apparatus and possible to hope for a reduction in manufacturing cost of the camera module.

In one aspect of the present invention, the lens drive device is configured such that: the base is an annular member; the lens holder is provided with a first protrusion formed on a bottom part of the lens holder; and when the lens holder is supported by the base, the first protrusion passes through a space defined by the base.

Further, in one aspect of the present invention, the lens drive device is configured such that: the lens holder is provided with a second protrusion formed on an outer wall of a side surface of the lens holder; and when the lens holder is supported by the base, the second protrusion abuts an upper surface of the base in such a manner as to suppress an inclination of the imaging lens.

Further, in one aspect of the present invention, the lens drive device is configured to include no lens barrel which is housed within the lens holder and within which the imaging lens is housed, wherein: the imaging lens has an outer shape that is tapered; and the lens holder has an inner wall provided with a lens engaging surface that engages with the outer shape of the imaging lens.

The configuration described above makes it possible to fix the imaging lens with respect to the lens holder. When the imaging lens is fixed, a positional relationship between the center of the lens holder and a center of the imaging lens is uniquely determined, and an inclination of the imaging lens with respect to the lens holder is also uniquely determined.

As a result, in a case where a camera module is configured by combining the lens drive device with the imaging element and the like, it is possible to reduce an amount of positional misalignment between the optical axis of the imaging lens and the center of the light-receiving surface of the imaging element. In this case, it is also possible to reduce an amount of angular misalignment between the optical axis of the imaging lens and the line normal to the imaging element. This makes it possible to more highly accurately determine the position of the imaging lens with respect to the imaging element.

Further, in one aspect of the present invention, the lens drive device is configured to include a lens barrel which is housed within the lens holder and within which the imaging lens is housed; the lens barrel has an outer shape that is tapered; and the lens holder has an inner wall provided with a barrel engaging surface that engages with the outer shape of the lens barrel.

The configuration described above makes it possible to fix the lens barrel with respect to the lens holder. When the lens barrel is fixed, a positional relationship between the center of the lens holder and a center of the lens barrel is uniquely determined, and an inclination of the lens barrel with respect to the lens holder is also uniquely determined.

Further, a camera module according to one aspect of the present invention includes: a lens drive device according one aspect of the present invention; an imaging element that receives light having passed through the imaging lens housed within the lens holder of the lens drive device; and a sensor cover that covers the imaging element.

Further, in one aspect of the present invention, the camera module is configured such that: the lens drive device has its base mounted on the sensor cover; the base has a raised part provided on a surface thereof opposite to the sensor cover; and the sensor cover has a depressed part, provided in a position opposite to the raised part, which engages with the raised part.

Further, in one aspect of the present invention, the camera module is configured such that: the lens drive device has its base mounted on the sensor cover; the base has a depressed part provided in a surface thereof opposite to the sensor cover; and the sensor cover has a raised part, provided in a position opposite to the depressed part, which engages with the depressed part.

The configuration described above makes it possible to highly accurately align the lens drive device and the sensor cover with each other. As a result, in the camera module, it is possible to reduce an amount of positional misalignment between the optical axis of the imaging lens and the center of the light-receiving surface of the imaging element. Further, in this case, it is also possible to reduce an amount of angular misalignment between the optical axis of the imaging lens and the line normal to the imaging element. This makes it possible to more highly accurately determine the position of the imaging lens with respect to the imaging element.

Further, in one aspect of the present invention, the camera module is configured such that: the raised part has an outer shape that is tapered; and the depressed part has an inner wall provided with a raised-part-engaging surface that engages with the outer shape of the raised part.

The configuration described above makes it possible to fix the lens drive device with respect to the sensor cover. When the lens drive device is fixed, a positional relationship between a center of the sensor cover and a center of the lens drive device is uniquely determined, and an inclination of the lens drive device with respect to the sensor cover is also uniquely determined.

Further, in one aspect of the present invention, the camera module includes: a lens drive device according one aspect of the present invention; an imaging element that receives light having passed through the imaging lens housed within the lens holder of the lens drive device; and a sensor cover that covers the imaging element, the lens holder having a first protrusion abutting an upper surface of the sensor cover, when the first protrusion is in abutment with the upper surface of the sensor cover, the lens holder being held lifted from the base by the sensor cover.

As described above, the present invention makes it possible to provide a small-sized camera module which can reduce deterioration of optical characteristics due to an optical axis shift caused by a variation in assembly and which enables an imaging element and an imaging lens to reach their potentials.

Further, the aspects of the present invention can also be expressed as follows:

The lens holder is structured to have a leg (first protrusion) protruding from a lower surface of the base. This makes it possible to cause the leg of the lens holder to surely abut on the sensor cover at the time of assembly of the lens drive device to the sensor cover. This makes it possible to highly accurately mount the lens to such an extent that an initial adjustment of a focus position at infinity is not necessary.

The lens holder has a tapered surface (holder tapered surface) provided as an outer wall surface thereof, and the tapered surface of the lens holder engages with a taper (holder tapered engaging surface) provided as an inner wall surface of the base. This engagement makes it possible to highly accurately align the center of the base and the center of the lens holder. This makes it also possible to compensate for an inclination of the lens holder.

Further, the lens holder has a raised part (second protrusion) provided on an outer surface thereof, and the raised part abut on an upper surface of the base. This makes it possible to, even if the leg of the lens holder is not in abutment with the base, compensate for an inclination of the lens holder.

Further, a lens unit (imaging lens) has an outer side surface formed in the shape of a part of a cone, and the lens holder has its inner wall side surface provided with a tapered surface (lens engaging surface) that engages with or is fitted in the outer side surface of the lens unit. This engagement makes it possible to align a center of the lens unit and the center of the lens holder with each other.

Further, the lens unit has a tapered surface serving as a receiving surface provided on an object-side edge of the lens unit, and this tapered surface engages with the tapered surface of the lens holder. With this, in a lens drive device structured such that the lens holder directly holds the lens unit, an optical center of the lens unit and an optical axis center of the lens holder can be aligned with each other by engaging the lens holder with the lens unit at the tapered surface of the lens holder.

Further, in the lens drive device, a raised part on the lower surface of the base and a depressed part in the upper surface of the sensor cover engage with each other, whereby the base and the sensor cover are positioned. This makes it possible to align the center of the sensor cover and the center of the base with each other.

In the lens drive device, a depressed part in the lower surface of the base and a raised part on the upper surface of the sensor cover engage with each other, whereby the base and the sensor cover are positioned. This makes it possible to align the center of the sensor cover and the center of the base with each other.

Further, in the lens drive device, a tapered surface provided in the raised part on or the depressed part in the lower surface of the base and a tapered surface provided in the raised part on or the depressed part in the upper surface of the sensor cover engage with each other, whereby the base and the sensor cover are positioned (the tapered surface of the depressed part is a raised-part-engaging surface). This makes it possible to align the center of the sensor cover and the center of the base with each other.

[Supplementary Notes]

For performance evaluation by a VCM alone (TILT evaluation of a lens holder with respect to a base) requires a part of the lens holder to be in abutment with the base. Therefore, the abutment of a first protrusion at a tapered surface or at a second protrusion is essential.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to (i) a lens drive device that can realize an autofocus function and (ii) a camera module including such a lens drive device and having the autofocus function.

### REFERENCE SIGNS LIST

1 Lens holder

2 Drive section

3 Base

6 Lens barrel

7 Lens holder

12 Holder tapered surface

13 First protrusion

14 Second protrusion

15 Lens engaging surface

31 Holder tapered engaging surface

32 Raised part

33 Depressed part

50 Imaging lens

51 Imaging lens

101 Lens drive device

102 Lens drive device

103 Lens drive device

104 Lens drive device

112 Imaging element

113 Sensor cover

132 Depressed part

200 Camera module

La Optical axis

Lb Optical axis

1. A lens drive device comprising:
a lens holder within which an imaging lens is housed; and
a base constituting a bottom part and supporting the lens holder,
the lens holder being provided with a holder tapered surface having a taper shape whose diameter becomes smaller from an upper surface side of the base toward to a bottom surface side of the base,
the base being provided with a holder tapered engaging surface that engages with the holder tapered surface,
when the lens holder is supported by the base, the holder tapered surface and the holder tapered engaging surface engaging with each other.

2. A lens drive device comprising:
a lens holder within which an imaging lens is housed; and
a base constituting a bottom part and supporting the lens holder,
the base being an annular member,
the lens holder being provided with a first protrusion formed on the bottom part of the lens holder and a second protrusion formed on an outer wall of a side surface of the lens holder,
when the lens holder is supported by the base, the first protrusion passing through a space defined by the base and the second protrusion abutting an upper surface of the base in such a manner as to suppress an inclination of the imaging lens.

3. The lens drive device as set forth in claim 1, wherein:
the base is an annular member;
the lens holder is provided with a first protrusion formed on a bottom part of the lens holder; and
when the lens holder is supported by the base, the first protrusion passes through a space defined by the base.

4. The lens drive device as set forth in claim 3, wherein:
the lens holder is provided with a second protrusion formed on an outer wall of a side surface of the lens holder; and
when the lens holder is supported by the base, the second protrusion abuts an upper surface of the base in such a manner as to suppress an inclination of the imaging lens.

5. The lens drive device as set forth in claim 1, comprising no lens barrel which is housed within the lens holder and within which the imaging lens is housed, wherein:
the imaging lens has an outer shape that is tapered; and
the lens holder has an inner wall provided with a lens engaging surface that engages with the outer shape of the imaging lens.

6. The lens drive device as set forth in claim 1, further comprising a lens barrel which is housed within the lens holder and within which the imaging lens is housed, wherein:
the lens barrel has an outer shape that is tapered; and
the lens holder has an inner wall provided with a barrel engaging surface that engages with the outer shape of the lens barrel.

7. A camera module comprising:
a lens drive device as set forth in claim 1;
an imaging element that receives light having passed through the imaging lens housed within the lens holder of the lens drive device; and
a sensor cover that covers the imaging element.

8. The camera module as set forth in claim 7, wherein:
the lens drive device has its base mounted on the sensor cover;
the base has a raised part provided on a surface thereof opposite to the sensor cover; and
the sensor cover has a depressed part, provided in a position opposite to the raised part, which engages with the raised part.

9. The camera module as set forth in claim 7, wherein:
the lens drive device has its base mounted on the sensor cover;
the base has a depressed part provided in a surface thereof opposite to the sensor cover; and
the sensor cover has a raised part, provided in a position opposite to the depressed part, which engages with the depressed part.

10. The camera module as set forth in claim 8, wherein:
the raised part has an outer shape that is tapered; and
the depressed part has an inner wall provided with a raised-part-engaging surface that engages with the outer shape of the raised part.

11. A camera module comprising:
a lens drive device as set forth in claim 2;
an imaging element that receives light having passed through the imaging lens housed within the lens holder of the lens drive device; and
a sensor cover that covers the imaging element,
the lens holder having a first protrusion abutting an upper surface of the sensor cover,
when the first protrusion is in abutment with the upper surface of the sensor cover, the lens holder being held lifted from the base by the sensor cover.
